(19) United States
(12) Patent Application Publication
(10) Pub. No.: US 2003/0223141 A1
(43) Pub. Date: Dec. 4, 2003

(54) Recording/reproducting apparatus and recording/reproducing method using rotary magnetic heads

(75) Inventors: Kenmei Masuda, Yokohama (JP); Shigeru Yamazaki, Yokohama (JP); Hidekazu Takeda, Hiratsuka (JP); Hideki Maruyama, Yokohama (JP); Toshio Tsuchiya, Mito (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/313,537

(22) Filed: Dec. 5, 2002

(30) Foreign Application Priority Data
May 29, 2002 (JP) 2002-154938

(51) Int. Cl. G11B 27/36; G11B 5/09

(52) U.S. Cl. 360/31; 360/53

(57) ABSTRACT

It is desirable to set an optimum bias current of an MR head in accordance with changes in MR head height, the wear difference of an MR element and the characteristics of the magnetic tape. In the present invention, test track 3 is provided in a beginning-of-tape position of a magnetic tape for setting a bias current for each of MR heads 11 and 12. A test signal is recorded on and reproduced from the test track before recording or reproducing data on/from data track 2. After detecting an error rate or a waveform asymmetry, the bias current is set in such a manner as to set the error rate or the waveform asymmetry in a predetermined range. The optimum current value is stored in memory 24, and the stored value is read out to set a bias current in a subsequent recording or reproduction.

### BACKGROUND OF THE INVENTION

1. Field of the Invention

The present invention relates to an apparatus and method for recording/reproducing a digital information signal and, particularly, to an apparatus and method for reproducing the digital information signal in an optimum state using a magnetoresistive head (hereinafter referred to as “MR head”), which is mounted on a rotary drum.

2. Description of the Related Art

The MR head uses the magnetic phenomenon of a recording medium, such as a magnetic tape or a magnetic disk, wherein electrical resistivity is changed due to a magnetic field signal generated by the recording medium. A sense current is supplied to the MR head to detect the resistivity change Since the resistivity change has a nonlinear characteristic with respect to an input magnetic field, a bias current, that sets an operation point of the MR head in a region having good linearity, is applied to the MR head. Currently available MR heads are designed to use the above current (hereinafter collectively referred to as “bias current”) in combination. To operate the MR head efficiently and obtain maximum reproduction output, it is necessary to optimize the bias current.

Various methods have been proposed for setting the bias current in a rotary head type magnetic recording/reproducing apparatus that employs the MR head and using magnetic tape as the recording medium. Japanese Patent Laid-open No. 10-177924 discloses a technique of controlling a bias current that defines an operation point of an MR head in accordance with head wear. In addition, Japanese Patent Laid-open No. 9-81909 proposes a method for setting an optimum bias current during recording/reproduction of actual data on/from a magnetic disk.

### BRIEF SUMMARY OF THE INVENTION

In a rotary head type apparatus using a magnetic tape as a recording medium, it is necessary to set a bias current value in accordance with a magnetic property specific to the tape. More specifically, it is necessary to set an optimum bias current that is suitable for the type of the tape, notably the thickness of the magnetic layer. Further, if the magnetic tape slides, a minute step (wear difference) is formed on a boundary between an MR element film and the film substrate. The minute step causes not only spacing loss in reproduction, but also a change in the optimum value of the bias current. These problems are not resolved in the above-mentioned related art literature.

In turn, in the method of setting the optimum bias current while running a magnetic tape, i.e., recording/reproducing actual data (verify mode), recording efficiency of the apparatus is remarkably decreased, that is., effective storage capacity is decreased since a large buffer memory capacity is undesirably consumed in order to store data which are transferred to the apparatus. If the apparatus is dedicated to data reproduction, a further disadvantage is that the effective data transfer rate is lowered, because a plurality of retries is required for minimizing errors.

This invention provides a recording/reproducing apparatus and a recording/reproducing method using rotary magnetic heads capable of setting an optimum bias current of an MR head in a short time. To achieve this, in the rotary magnetic head type recording/reproducing apparatus of the present invention, a magnetic tape has a test track for recording and reproducing a test signal for setting a bias current for the MR head in a predetermined region other than a region of a data track for recording the digital signal. The rotary magnetic head type recording/reproducing apparatus includes a recording circuit which supplies a recording current to the recording magnetic head; a reproducing circuit which processes a reproduction output of the MR head; a current supplying circuit which supplies a bias current to the MR head; and a current controlling circuit which reproduces the test signal from the test track on the magnetic tape and sets the bias current to be supplied to the MR head in accordance with a result of the reproduction.

In this aspect of the present invention, before recording or reproducing the digital signal on or from the data track of the magnetic tape, the test signal is reproduced from the test track to set the bias current to be supplied to the MR head. The test signal to be recorded on the test track is a random signal, and the error rate of the reproduction signal of the random signal is detected to set the bias current to be supplied to the MR head in such a manner that the error rate falls within a predetermined range. Alternatively, the test signal to be recorded on the test track is a low frequency signal having a period of at least 2T (T is a minimum bit period of a recording frequency), and asymmetry of a waveform of a reproduction signal of the test signal is detected to set the bias current to be supplied to the MR head in such a manner that a value of the asymmetry falls within a predetermined range.

To provide these benefits the magnetic tape has a test track for recording and reproducing a test signal which is used for setting a bias current value for the MR head in a predetermined region other than a region of a data track for recording the digital signal. Also the recording/reproducing method includes the steps of reproducing the test signal from the test track before recording or reproducing the digital signal on or from the data track of the magnetic tape; setting a bias current to be supplied to the MR head in accordance with a result of the reproduction of the test signal; and supplying the set bias current to the MR head to reproduce the digital signal.

These and other benefits, features and advantages of the present invention will become more readily apparent from the following detailed description when taken in conjunction with the accompanying drawings wherein:

### BRIEF DESCRIPTION OF THE DRAWINGS

FIG. 1 is a diagram showing a tape format for recording and reproducing in a rotary head type recording/reproducing apparatus according to the present invention;

FIG. 2 is a diagram showing the arrangement of recording heads and reproducing MR heads mounted on a rotary drum of the rotary head type recording/reproducing apparatus according to the present invention;

FIG. 3 is a block diagram showing a circuit configuration of the rotary head type recording/reproducing apparatus according to the present invention;

FIG. 4 is a characteristic diagram showing a relationship between an MR head resistivity and an optimum bias current;

FIG. 5 is a characteristic diagram showing a relationship between the MR head element height and an optimum bias current;

FIG. 6 is a characteristic diagram showing a relationship between a bias current and an error rate;

FIG. 7 is a characteristic diagram showing a relationship between a bias current and asymmetry of a reproduction waveform;

FIG. 8 is a diagram showing an example of a reproduction signal waveform of an MR head;

FIG. 9 is a flowchart showing operations of setting a bias current for the MR head at the time of recording according to the present invention; and

FIG. 10 is a flowchart showing operations of setting a bias current for the MR head at the time of reproduction according to the present invention.

### DETAILED DESCRIPTION OF THE INVENTION

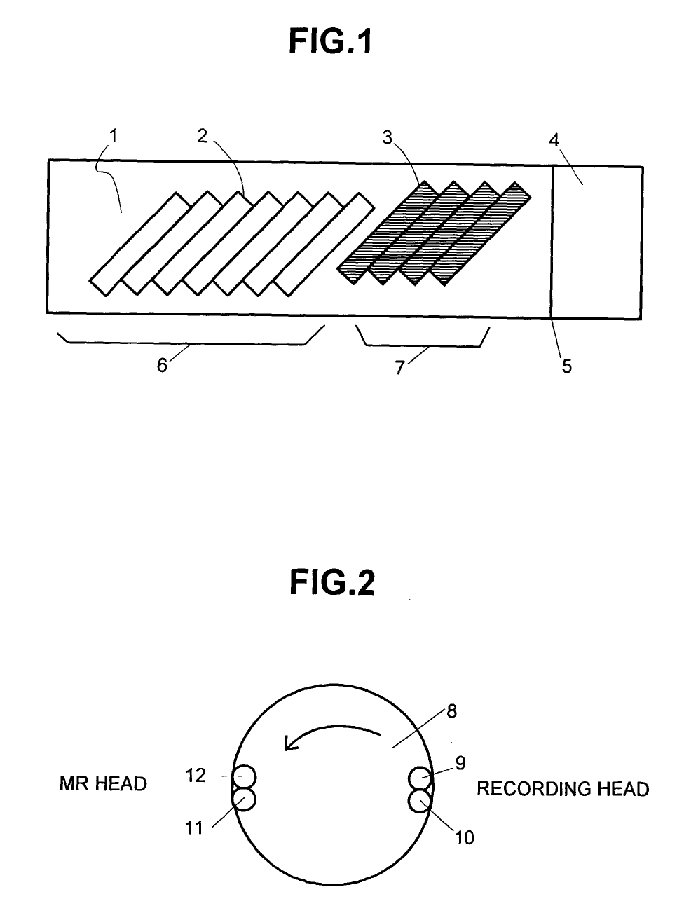

Embodiments of the present invention will be described in detail below. FIG. 1 is a schematic diagram showing a tape pattern of a magnetic tape that is used for recording and reproducing data in a rotary-magnetic-head-type apparatus according to the present invention. A magnetic tape 1 is provided with data recording tracks 2 and test tracks 3. Test tracks 3 are located between data recording tracks 2 and a BOT (Beginning Of Tape) position 5. A region occupied by data recording tracks 2 is referred to as an actual data area 6, and a region occupied by test tracks 3 is referred to as a rehearsal area 7.

Although four test tracks are shown in FIG. 1, the number of test tracks is not limited, except that having two or more test tracks is advantageous. When recording or reproduction is finished, the tape is unloaded after being rewound to BOT position 5. Therefore, it is possible to immediately scan rehearsal area 7, which is near BOT position 5, of the tape inserted into the apparatus.

FIG. 2 is a schematic diagram showing a construction in which heads are disposed on a drum of a rotary-magnetic-head-type apparatus according to the present invention. Recording heads 9 and 10 as well as reproducing MR heads 11 and 12 are mounted on a rotary drum 8.

The recording pattern shown in FIG. 1 is recorded simultaneously by recording heads 9 and 10 and reproduced by reproducing heads 11 and 12. The number of recording heads and reproducing heads is not limited. There may be more than one of each.

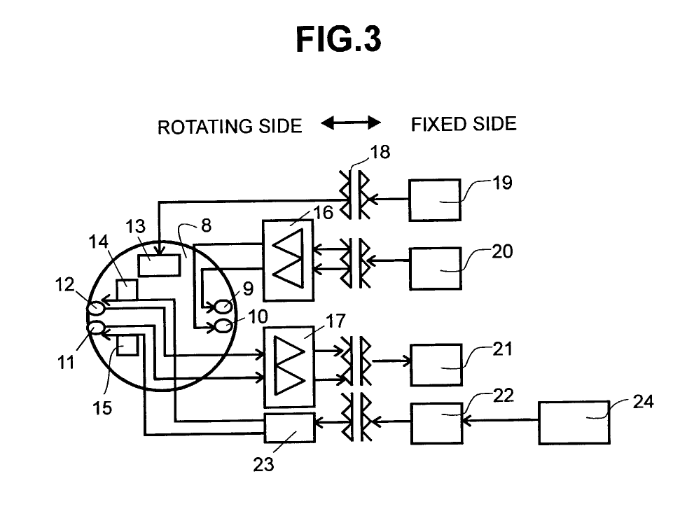

FIG. 3 shows a circuit configuration for performing recording and reproducing in the rotary-magnetic-head-type apparatus according to a preferred embodiment of the present invention. A power supply circuit 13, current circuits 14 and 15, respectively, for supplying a bias current to the MR heads 11 and 12, a recording amplifier 16, a reproducing amplifier 17, and a current controller 23 are mounted on the side of rotary drum 8. On a fixed side, a power signal generating circuit 19, a recording circuit 20, a reproducing circuit 21, a bias current controlling circuit 22, and a memory 24 are provided. A rotary transformer 18 transmits a signal between the rotating side and the fixed side.

Recording and reproducing operations of the rotary-magnetic-head-type apparatus is described below with reference to FIG. 3. At the time of recording, a recording signal is transmitted from recording circuit 20 disposed on the fixed side to the rotating side via rotary transformer 18. The signal is then amplified by recording amplifier 16 in rotary drum 8 and is recorded on a tape by recording heads 9 and 10. In this embodiment of the invention, a voltage is supplied from power supply circuit 13 to recording amplifier 16, reproduction amplifier 17, and current circuits 14 and 15 on the rotary side. A rectangular (or sinusoidal) wave signal voltage is applied from power signal generating circuit 19, which is disposed on the fixed side to power supply circuit 13 via rotary transformer 18, and power supply circuit 13 regulates the voltage to supply the regulated voltage.

At the time of reproduction, signals reproduced by the MR heads 11 and 12 are amplified by reproduction amplifier 17 and transmitted to reproduction circuit 21 via rotary transformer 18. In this embodiment of the invention, the bias currents are supplied from current circuits 14 and 15 to MR heads 11 and 12, and current controller 23 controls a magnitude of each of the bias currents. The bias currents generated by current circuits 14 and 15 are so controlled as to achieve a maximum reproduction output. Memory 24 stores the data of the bias current achieved at this time, so that the bias currents may also be set by reading out the data from memory 24.

According to the present embodiment, it is possible to detect and set the optimum bias currents of the plurality of MR heads that are mounted on the rotary drum immediately after the magnetic tape is inserted. Therefore, it is possible to omit the process of setting the optimum bias currents at the same time as detecting errors by the verify mode, which has been performed in the conventional technique, in the case where data are transferred from a host. Further, since it is unnecessary to rewrite the transferred data on another region of the tape, efficient data writing is achieved without consuming the storage capacity of the apparatus.

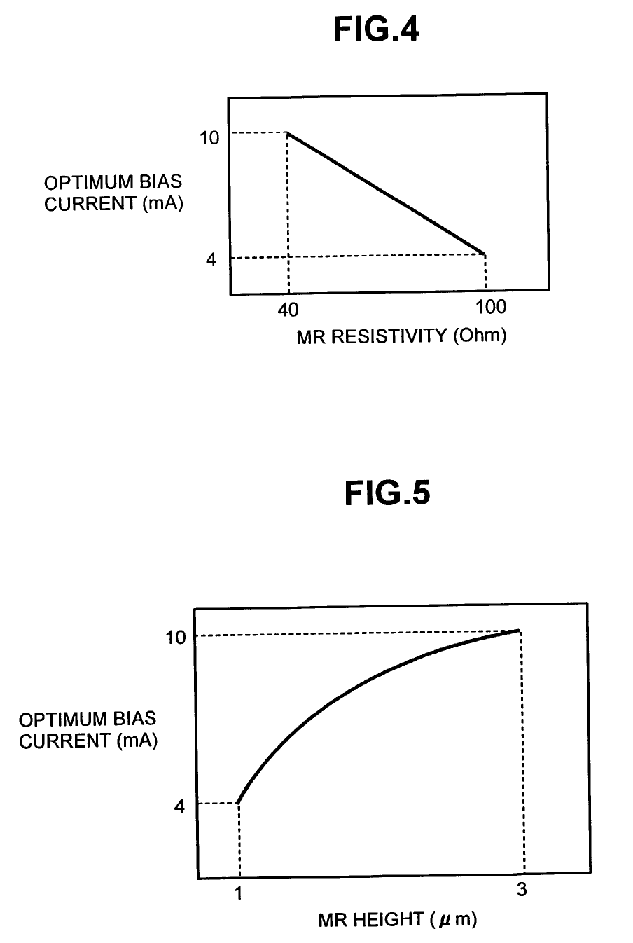

The relationship between an MR head characteristic and an optimum bias current is shown in each of FIGS. 4 to 8. A relationship between an element resistivity of the MR head and a bias current optimum for minimizing an error rate of data is shown in FIG. 4. It is necessary to set, or reduce, the bias current in accordance with an increase in the resistivity of the MR head.

The relationship between a height of the MR head, i.e., a height of the MR element, and an optimum bias current value is shown in FIG. 5. With a reduction in the MR element height, the resistivity is increased while the optimum bias current value is decreased. In other words, since the height of the MR element is decreased with progress in MR head wear, the optimum bias current must be decreased with the progress in MR head wear.

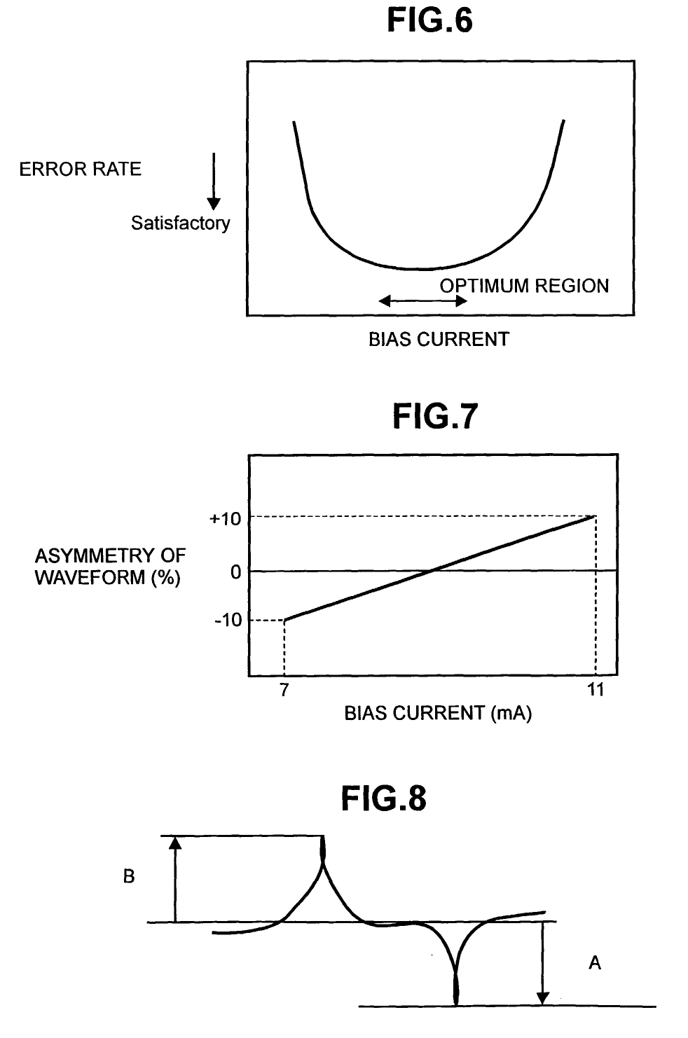

FIG. 6 shows the relationship between error rate of the MR head and a bias current value is shown in FIG. 6. The error rate exhibits a U-shaped characteristic with respect to the bias current, and there is an optimum region as indicated in the diagram. Such characteristic is due to waveform distortion that changes depending on the bias current, and the error rate rises when the distortion is expanded.

However, if a step (wear difference) is formed between the MR element and the substrate, the above settings are insufficient because the formation of the step causes the U-shaped characteristic shown in FIG. 6 to shift to a region of relatively high bias current. Further, if a tape magnetic layer is too thick, a magnetic field to be retained by the medium becomes so strong that the MR element tends to be saturated, thereby raising the error rate. As a result, the U-shaped characteristic shifts to a region where the bias current is relatively low.

An asymmetric relationship between a bias current and an output waveform is shown in FIG. 7. The linear relationship is achieved because the error rate of FIG. 6 depends on asymmetry (a type of distortion) of a reproduction waveform. Although one straight line (approximation) is shown in FIG. 7, a point on which the asymmetry is 0% exists in each of the MR resistivities.

The asymmetry is explained below with reference to FIG. 8. The asymmetry is defined by a ratio of difference between an output value in a positive direction and an output value in a negative direction of a reproduction pulse, to a sum of the output value in the positive direction and the output value in the negative direction of the reproduction pulse. A definition expression of the asymmetry is shown below as Expression (1).

Asymmetry=[((B−A)/(B+A))]×100(%) (1)

If the output values in positive and negative directions are the same, the asymmetry becomes 0% since A=B. The distortion of the waveform is expanded with an increase in magnitude of the asymmetry, thereby raising the error rate.

In the case of optimizing the error rate by using the asymmetry thus detected, a low frequency signal having a period of at least 2T or less (T is a minimum bit period of recording frequency) is suitably used as a test recording signal. In turn, in the case of directly detecting the error rate, a random signal is suitably used as the test-recording signal. A frequency component of a signal to be recorded on a tape depends on a recording modulation mode, and an output at the 2T signal frequency has considerable influence on the error rate in a partial response mode or like modes.

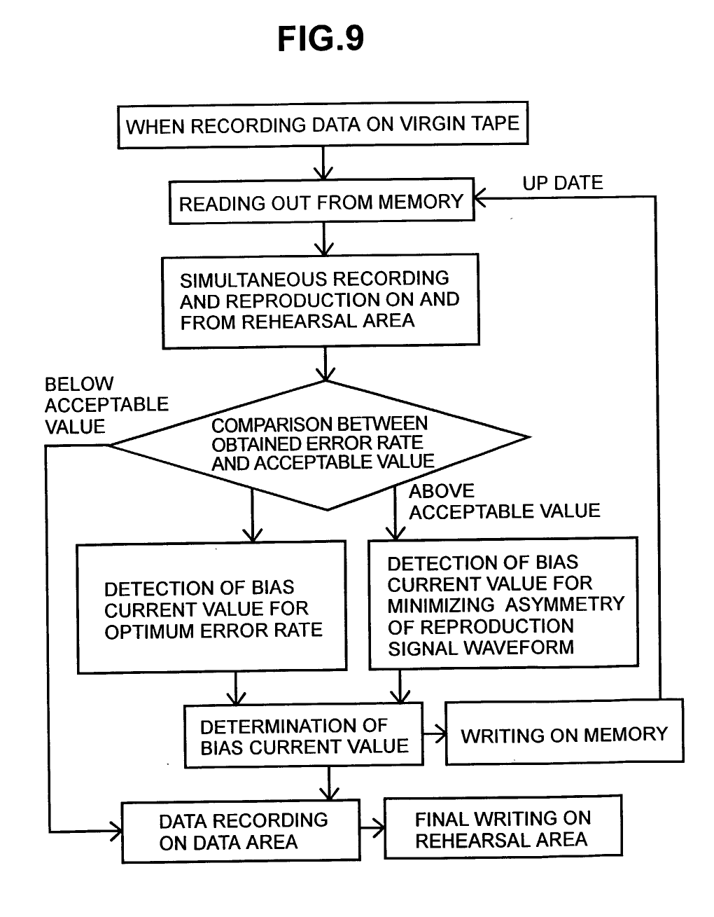

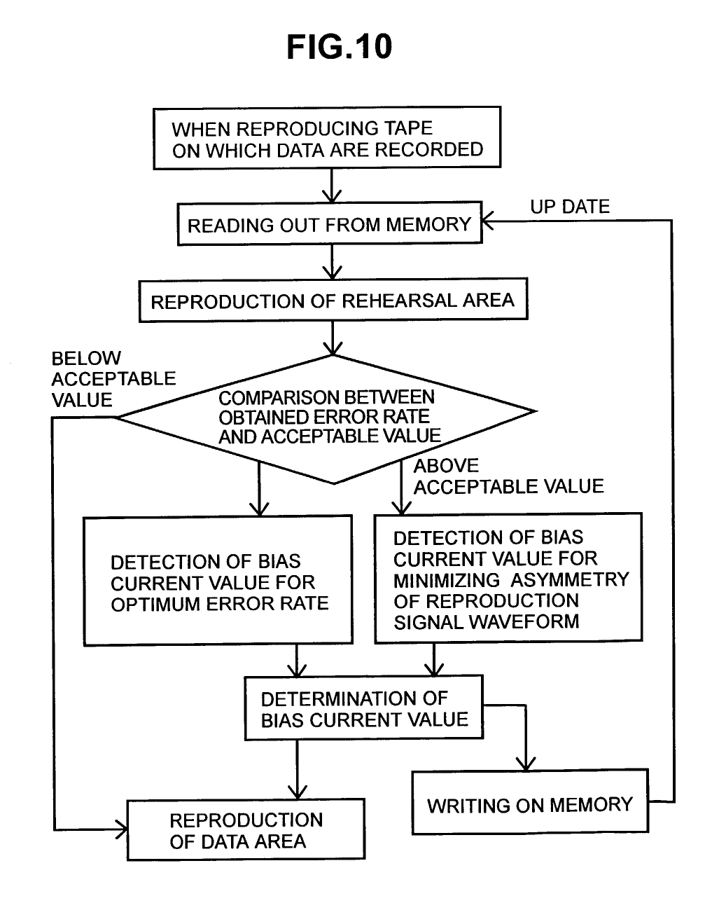

FIGS. 9 and 10 are flow charts for setting a bias current of an MR head of the present invention in accordance with respective states of the head immediately before recording and reproduction. An operation of recording data on a virgin tape is shown in FIG. 9. An initial value of the bias current is the (ex-factory initial value or a bias current value updated when the apparatus is used) is stored in memory 24 in the recording/reproducing apparatus. Since MR heads in general have variations in element characteristic and height, the bias current is set at the time of assembly. Before recording/reproducing actual data, a test signal is simultaneously recorded and reproduced on and from a rehearsal area of the tape in order to detect an error rate. At this point, the bias current value that has been stored in the memory 24 is read out, so that the MR head is operated at the bias current value. If the error rate is equal to or lower than a threshold value defined in the apparatus, the error rate is set as a normal state, and then the actual data is moved to a data area on the tape to be recorded thereon. However, if the error rate at the initial bias current value is higher than the threshold value, the bias current is changed to detect an error rate by the simultaneous recording and reproduction procedure again. A bias current that achieves an error rate equal to or lower than the threshold value is detected by repeating the above operation. The thus-obtained bias current value is stored in the memory 24 as a new current value. After that, the actual data is moved to the data area on the tape to be recorded thereon. In addition, a waveform asymmetry value (%) may be used in place of the error rate as an index for setting the bias current value.

An operation of reproducing data that has been recorded on a tape is shown in FIG. 10. Bias currents for various types of tapes are set in memory 24. A backward-compatible low-recording-density tape has a relatively thick magnetic layer and, therefore, it is necessary to set the bias current as low as possible in order to suppress the distortion by limiting a magnetic flux reproduced by the MR head. Accordingly, bias current values for various types of tapes are stored in the memory 24. However, the characteristic of the MR head immediately before reproduction is susceptible to change due to head wear, for example, so that an effective bias current may be different from the set bias current value in some cases. Also in such cases, an optimum value can be detected by reproducing the rehearsal area of the tape inserted into the apparatus. The bias current values stored in memory 24 vary from one another depending on the types of tapes.

In the present invention, the test track is recorded on the BOT position; however, the rehearsal area may be located near the BOT position if a recording apparatus unloads without failure at the tape-end position. Alternatively, the rehearsal area may be located at any predetermined portion of the tape other than the tape-end, the BOT position, and the data track. In this case, it is unnecessary to rewind the tape to the BOT position, so that rapid switching over from the test operations to the actual reproduction operations is realized.

According to the present invention as described above, an optimum bias current value of each of a plurality of MR heads mounted on a rotary drum is detected and set immediately after insertion of a magnetic tape. Therefore, the present invention can provide a recording/reproducing apparatus which is always in the best condition, highly reliable, and excellent in operability.

The invention may be embodied in other specific forms without departing from the spirit or essential characteristics thereof The present embodiment is therefore to be considered in all respects as illustrative and not restrictive, the scope of the invention being indicated by the appended claims rather than by the foregoing description, and the range of equivalency of the claims are therefore intended to be embraced therein.

What is claimed is:

1. A rotary magnetic head type recording/reproducing apparatus for recording and reproducing a digital signal on a magnetic tape using a recording magnetic head and a reproducing magneto resistive head mounted on a rotary drum, the magnetic tape having a test track for recording and reproducing a test signal for setting a bias current for the magneto resistive head in a predetermined region other than a region of a data track for recording the digital signal, comprising:
a recording circuit which supplies a recording current to the recording magnetic head;
a reproducing circuit which processes a reproduction output of the magneto resistive head;
a current supplying circuit which supplies a bias current to the magneto resistive head; and
a current controlling circuit which reproduces the test signal from the test track on the magnetic tape in the reproducing circuit and sets the bias current to be supplied to the magneto resistive head by controlling the current supplying circuit in accordance with a result of the reproduction.

2. The rotary magnetic head type recording/reproducing apparatus according to claim 1, wherein the current controlling circuit reproduces the test signal from the test track so as to set the bias current to be supplied to the magneto resistive head before recording or reproducing the digital signal on or from the magnetic tape.

3. The rotary magnetic head type recording/reproducing apparatus according to claim 1, wherein the test signal to be recorded on the test track is a random signal, and the current controlling circuit detects an error rate of a reproduction signal of the random signal so as to set the bias current to be supplied to the magneto resistive head in such a manner that the error rate falls within a predetermined range.

4. The rotary magnetic head type recording/reproducing apparatus according to claim 1, wherein the test signal to be recorded on the test track is a low frequency signal having a period of at least 2T (T is a minimum bit period of a recording frequency), and the current controlling circuit detects asymmetry of a waveform of a reproduction signal of the test signal so as to set the bias current to be supplied to the magneto resistive head in such a manner that a value of the asymmetry falls within a predetermined range.

5. The rotary magnetic head type recording/reproducing apparatus according to claim 1, wherein the test track is located near a beginning-of-tape position of the magnetic tape.

6. The rotary magnetic head type recording/reproducing apparatus according to claim 1, further comprising a memory which stores a value of the bias current to be supplied to the magneto resistive head after the bias current has been set.

7. The rotary magnetic head type recording/reproducing apparatus according to claim 6, wherein the current controlling circuit reads out the bias current stored in the memory so as to set a bias current to be supplied to the magneto resistive head at the time of reproducing the test signal of the magnetic tape.

8. The rotary magnetic head type recording/reproducing apparatus according to claim 6, wherein bias current values for a plurality of types of tapes having different magnetism layer thicknesses are stored in the memory, and a bias current value which corresponds to the type of a magnetic tape which is inserted into the apparatus is selectively read out from the memory.

9. A recording/reproducing method for recording and reproducing a digital signal on and from a magnetic tape using a recording magnetic head and a reproducing magneto resistive head which are mounted on a rotary drum, characterized in that:
the magnetic tape has a test track for recording and reproducing a test signal which is used for setting a bias current value for the magneto resistive head in a predetermined region other than a region of a data track for recording the digital signal; and
the recording/reproducing method comprises the steps of:
reproducing the test signal from the test track before recording or reproducing the digital signal on or from the data track of the magnetic tape;
setting a bias current to be supplied to the magneto resistive head in accordance with a result of the reproduction of the test signal; and
supplying the set bias current to the magneto resistive head so as to reproduce the digital signal.

10. The recording/reproducing method according to claim 9, wherein the test signal to be recorded on the test track is a random signal, and an error rate of a reproduction signal of the random signal is detected so as to set the bias current to be supplied to the magneto resistive head in such a manner that a value of the error rate falls within a predetermined range.

11. The recording/reproducing method according to claim 9, wherein the test signal to be recorded on the test track is a low frequency signal having a period of at least 2T (T represents a minimum bit period of a recording frequency), and asymmetry of a waveform of a reproduction signal of the low frequency signal is detected so as to set the bias current to be supplied to the magneto resistive head in such a manner that a value of the asymmetry falls within a predetermined range.

12. The recording/reproducing method according to claim 9, wherein a value of a bias current to be supplied to the magneto resistive head is stored in a memory after the bias current has been set.

13. The recording/reproducing method according to claim 12, wherein the bias current value stored in the memory is read out when reproducing the test signal of the magnetic tape so as to set a bias current to be supplied to the magneto resistive head.

14. The recording/reproducing method according to claim 13, wherein a bias current to be supplied to the magneto resistive head is set based on the bias current value stored in the memory; a characteristic of a reproduction signal from the test track is estimated; and, if the characteristic is not within the predetermined range, the bias current to be supplied is repeatedly changed until a characteristic which is within the predetermined
